(19) United States
(12) Patent Application Publication
(10) Pub. No.: US 2003/0221527 A1
(43) Pub. Date: Dec. 4, 2003

(54) Pipe cutter

(76) Inventor: Mei-Chu Lee, Tainan Hsien (TW)

Correspondence Address: Mei-Chu Lee, P.O. Box 90, Tainan City, 704, TW

(21) Appl. No.: 10/159,040

(22) Filed: Jun. 3, 2002

(51) Int. Cl. B23D 21/14

(52) U.S. Cl. 83/184; 83/187

(57) ABSTRACT

A piper cutter in the invention comprises a spindle, a fixing disk, a locating seat, a cutting member, a stop member, and two nuts. The locating seat can slide along the spindle to move the cutting member to a location at a level of a required length of a pipe body to be cut, whereby after a socket head of a power drive unit is locked on a fixed head of the spindle, the power drive unit is actuated to rotate the spindle with a lower portion of the spindle moved sideways to make the cutting member follow the rotation of the spindle to cut the pipe body accordingly, thus enabling the piper cutter to be convenient and quick in use; time-saving and labor-saving; adapted to cut pipe bodies with different thickness, bore sizes or length; and, provided with good working efficiency, economical benefits and high utility in industry.

### BACKGROUND OF THE INVENTION

1. Field of the Invention

This invention relates to a pipe cutter, particularly to one having a locating seat capable of sliding along a spindle to move a cutting member to a location at a level of a required length of a pipe body to be cut, whereby after a socket head of a power drive unit is locked on a fixed head disposed at a top of the spindle, the power drive unit can be actuated to rotate the spindle with a lower portion of the spindle moved sideways to make the cutting member follow the rotation of the spindle to cut the pipe body accordingly, thus enabling the piper cutter of the present invention to be convenient and quick in use; time-saving and labor-saving; adapted to cut pipe bodies with different thickness, bore sizes or length; and, provided with good working efficiency, economical benefits and high utility in industry.

2. Description of the Prior Art

Generally speaking, when a house is in building, firstly reinforcing steel-bars 10 are bound firmly, and then vertical pipes 11 and horizontal pipes 12 are installed in-between the reinforcing steel-bars 10, as shown in FIG. 1. A tee joint is often used to connect respectively with a vertical pipe 11 and a horizontal pipe 12. However, before being connected with the tee joint, the vertical pipe 11 and the horizontal pipe 12 have to be cut to a required length according to actual need. In a conventional cutting way, a piper worker will hold a cutting blade to cut a pipe directly by hunkering to the ground and bending downwardly to put the cutting blade into the firmly combined reinforcing steel-bars 10 to cut the pipe body carefully and slowly. Therefore, it often spends 10 to 20 minutes for the pipe worker to cut a single pipe, and then additional time is needed to trim an uneven edge of the pipe, which is indeed time-consuming and labor-consuming in work. The worst is that the pipe worker may cut peripheral facilities around the pipe carelessly, thus causing unnecessary damages and loses.

### SUMMARY OF THE INVENTION

The main purpose of the invention is to offer a pipe cutter capable of conveniently and promptly cutting pipe bodies without causing any damage to peripheral facilities outside the pipe bodies and being adapted to cutting pipe bodies of different thickness, bore sizes and length.

The main feature of the invention is to provide a pipe cutter mainly including:

a spindle having a fixed head disposed at a top thereof, a locating rod disposed under the fixed head, a stop flange disposed under the locating rod, and a scale indicated on a body thereon;

a fixing disk fitly covered on the locating rod of the spindle and having an engagement groove disposed therein, a bearing securely mounted in the engagement groove, and a plurality of annual grooves disposed therein, the engagement groove provided with a through hole disposed therein;

a locating seat fitly covered on the body of the spindle and having a channel formed in a center thereof, a stop flange disposed at an upper portion thereof, and a stem disposed at a lower portion thereof, the stop flange having a notch formed thereon in communication with the channel and a tenon protruded at a lower portion thereof, the stem having a plurality of set members for firmly fixing the locating seat on the spindle;

a cutting member fitly covered on the locating seat and having a through hole formed in a center thereof, the through hole having a mortise formed at one side thereof;

a stop member fitly covered on the locating seat and positioned below the cutting member and having a bearing mounted thereon and a through hole formed in a center thereof;

two securing members respectively disposed on the locating rod of the spindle and the locating seat, one of the two securing members capable of securing the fixing disk on the spindle in location, and the other one of the two securing members capable of securing the cutting member and the stop member on the locating seat in location.

### BRIEF DESCRIPTION OF DRAWINGS

This invention will be better understood by referring to the accompanying drawings, wherein:

FIG. 1 is a schematic view of a conventional structure being in building and combined with reinforcing steel-bars and pipes;

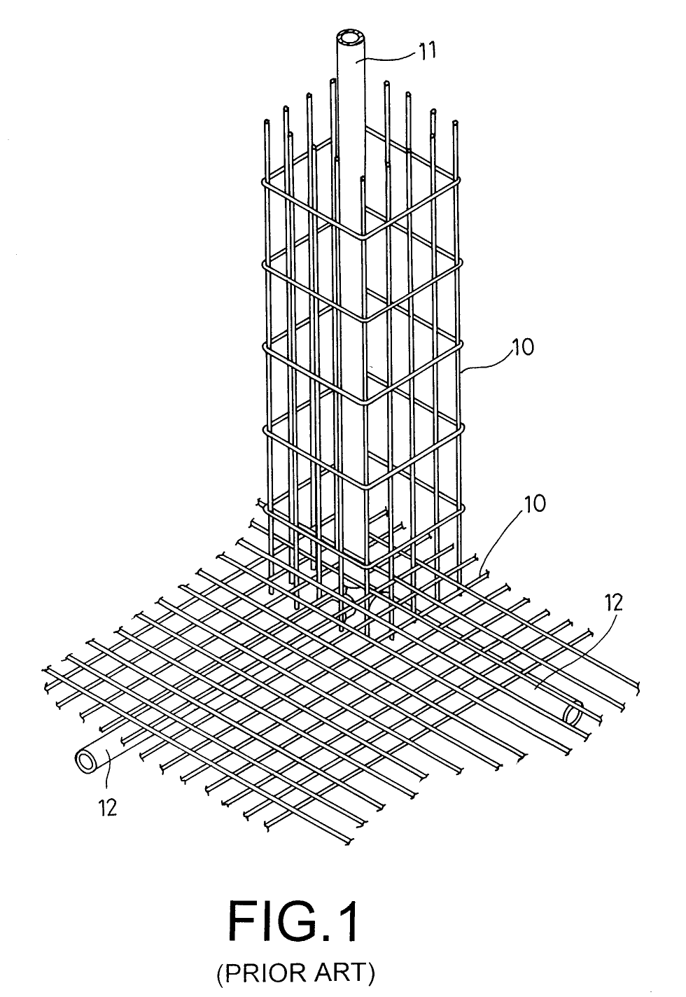

FIG. 2 is an exploded perspective view of a pipe cutter in the present invention;

FIG. 3 is a perspective view of the pipe cutter in the present invention;

FIG. 4 is a schematic sectional view of the pipe cutter in the present invention being inserted in a pipe; and,

FIG. 5 is a schematic sectional view of the pipe cutter in the present invention being in a sideway-cutting status.

### DETAILED DESCRIPTION OF THE PREFERRED EMBODIMENT

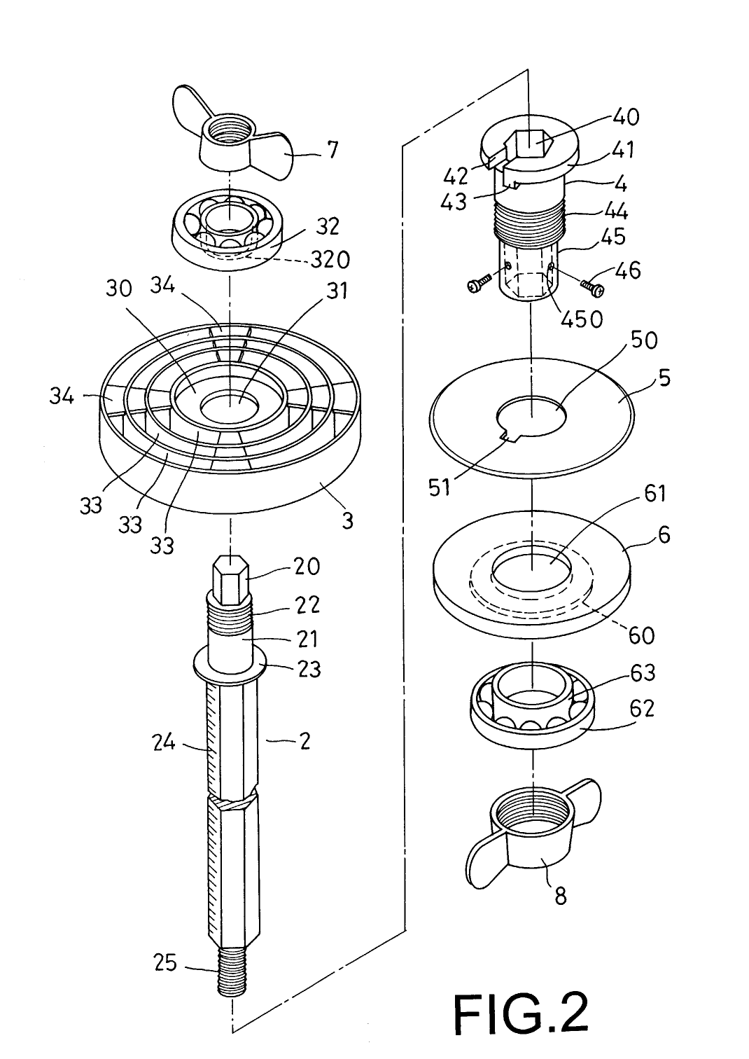

A preferred embodiment of a pipe cutter in the present invention, as shown in FIG. 2, mainly includes a spindle 2, a fixing disk 3, a locating seat 4, a cutting member 5, a stop member 6, and two securing members 7, 8.

The spindle 2 shaped as a polygonal rod body has a fixed head 20 disposed at a top thereof, a location rod 21 disposed under the fixed head and provided with threads 22, a stop flange 23 disposed under the locating rod 21, a scale 24 indicated on the rod body, and a screw rod 25 disposed at an upper end thereof.

The fixing disk 3 fitly covered on the locating rod 21 of the spindle 2 has an engagement groove 30 disposed in a center of a top surface thereof, a through hole 31 formed in the engagement groove 30, a bearing 32 securely mounted in the engagement groove 30, a plurality of annual grooves 33 disposed therein, and a plurality of connecting pieces 34 disposed therein for connecting the plurality of annual grooves 33. The bearing 32 has a flange 320 disposed at a bottom thereof for extending into the through hole 31 of the fixing disk 3.

The locating seat 4 fitly covered on the body of the spindle 2 has a channel 40 formed in a center thereof and having a shape of polygon same as that of the body of the spindle 2, a stop flange 41 disposed at an upper portion thereof, external threads 44 disposed thereon, and a stem 45 disposed at a lower portion thereof. The stop flange 41 has a notch 42 formed thereon and in communication with the channel 40, and a tenon 43 protruded at a lower portion thereof. The stem 45 has a plurality of screw holes 450 disposed in sidewalls thereof in communication with the channel 40 for being screwed with a plurality of set members 46 that can be screws.

The cutting member 5 fitly covered on the locating seat 4 has a through hole 50 formed in a center thereof. A mortise 51 is disposed at one side of the through hole 50.

The stop member 6 fitly covered on the locating seat 4 and positioned below the cutting member 5 has an engagement groove 60 disposed at a bottom thereof, and a bearing 62 securely mounted in the engagement groove 60. A through hole 61 is formed in a center of the engagement groove 60. The bearing 62 has a flange 63 disposed at a bottom thereof for extending into the through hole 61 of the stop member 6.

The two securing members 7, 8 are respectively screwed on the locating rod 21 of the spindle 2 and the locating seat 4, and can be wing nuts convenient for screwing.

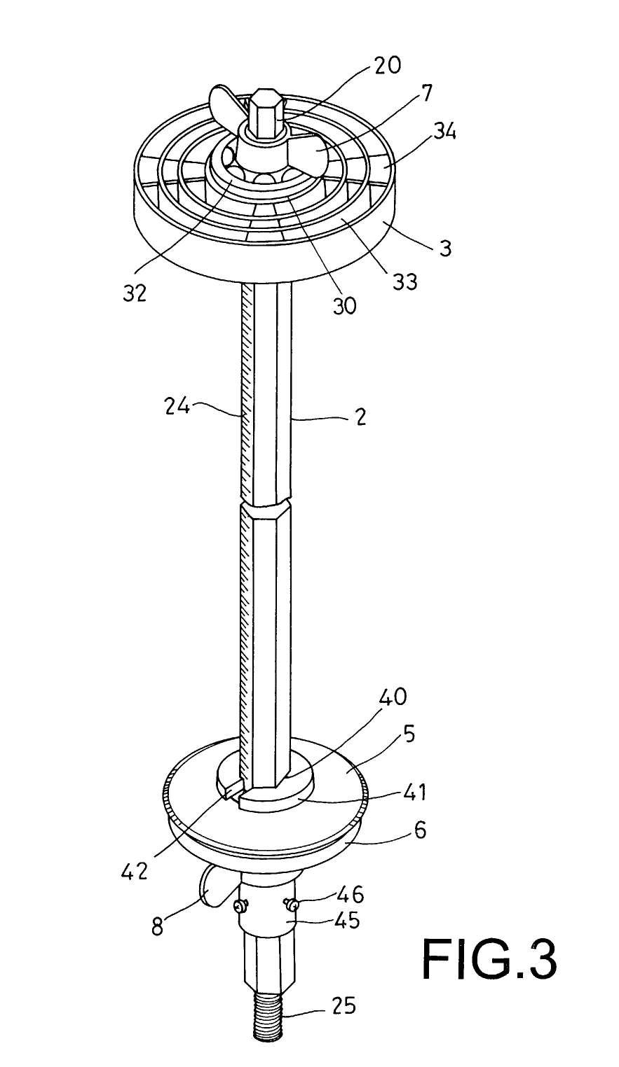

In assembling, referring to FIGS. 2, 3 and 4, firstly fitly cover the fixing disk 3 on the locating rod 21 of the spindle 2 with the flange 320 of the bearing 32 of the fixing disk 3 pressed against the stop flange 23 of the spindle 2, and then have the securing member 7 screwed with the threads 22 of the locating rod 21 of the spindle 2 to make the fixing disk 3 securely fixed on the spindle 2 in location. Secondly, fitly cover the locating seat 4 on the rod body of the spindle 2 with the rod body of the spindle 2 extending through the channel 40 of the locating seat 4 and with the notch 42 of the locating seat 4 aligned with the scale 24 of the spindle 2. Thirdly, screw the set members 46 to the stem 45 of the locating seat 4 to make the locating seat 4 securely fixed on the rod body of the spindle 2. Fourthly, fitly cover the cutting member 5 on the locating seat 4 with the mortise 51 of the cutting member 5 engaged by the tenon 43 of the locating seat 4. Fifthly, fitly cover the stop member 6 on the locating seat 4 at a location below the cutting member 5 with the flange 63 of the bearing 62 of the stop member 6 pressed against a lower surface of the cutting member 5. Finally, have the securing member 8 screwed with the external threads 44 of the locating seat 4 to fix the cutting member 5 and the stop member 6 on the locating seat 4 in location, by which an assemblage of the whole structure of the pipe cutter in the present invention is completed.

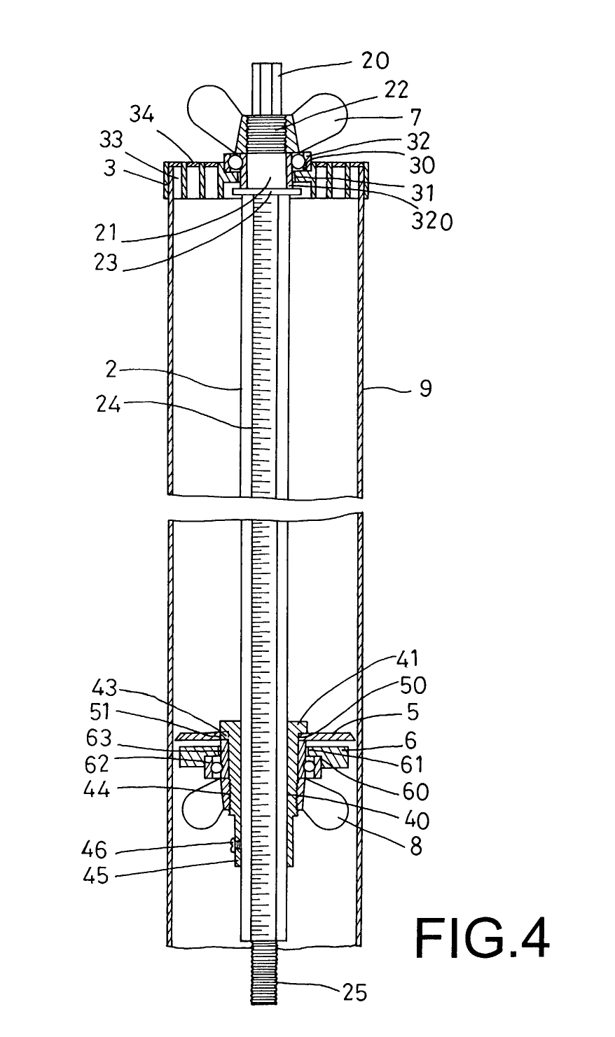

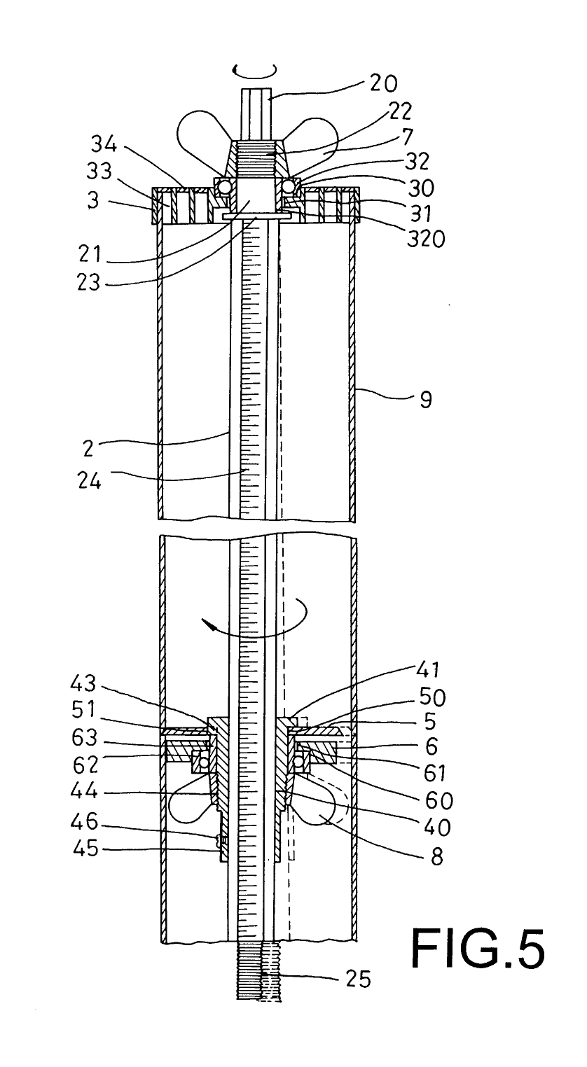

In using, firstly release the set members 46 of the stem 45 of the locating seat 4 so that the locating seat 4 can slide along the spindle 2 to a location at a level of a required length of a pipe 9 to be cut, and then screw the set members 46 tightly to make the locating seat 4 firmly secured on the spindle 2 with the notch 42 of the stop flange 41 of the locating seat 4 aligned with the scale 24 so that it is clear to see that the cutting member 5 is just positioned in the predetermined location of the scale 24 for precisely cutting the pipe 9 in the required length. After the cutting member 5 is adjusted to be in the predetermined location, extend the whole piper cutter of the present invention from an upper end of the pipe 9 into a body of the pipe 9, and then make the upper end of the pipe 9 securely engaged with one of the annual grooves 33 of the fixing disk 3 whose bore size is matched with that of the upper end of the pipe 9 with the fixed head 20 of the spindle 2 protruded outside the upper end of the pipe 9 and with the lower portion of the spindle 2, the locating seat 4, the cutting member 5 and the stop member 6 extending inside the body of the pipe 9, as shown in FIG. 4. Thirdly, cover and lock a socket head of a power drive unit on the fixed head 20 of the spindle 2, and then actuate the power drive unit to rotate the spindle 2, by which the locating seat 4 will follow the rotation of the spindle 2 to make the cutting member 5 cut off the body of the pipe 9 accordingly. Since the spindle 2 itself has a length and the upper end of the spindle 2 is fixed during the rotation, the lower portion of the spindle 2 will be moved sideways to make the cutting member 5 cut off the body of the pipe 9 precisely, as shown in FIG. 5, which is convenient and quick in use, time-saving, labor-saving, and capable of increasing working efficiency and economical benefits.

Besides, the cutting member 5 is designed to have an external diameter a little smaller than an internal diameter of the pipe 9 so that the cutting member 5 is able to cut off fitly covered on the pipe 9 by following the sideway movement of the lower portion of the spindle 2. The stop member 6 is designed to have an external diameter a little smaller than that of the cutting member 5 so that the stop member 6 has a radius a little smaller than that of the cutting member 5 with a radial differential between the stop member 6 and the cutting member 5 just to be the thickness of the body of the pipe 9, by which after the body of the pipe 9 is cut off by the cutting member 5, the stop member 6 will stop against an inner wall of the body of the pipe 9 to prevent the cutting member 5 from continuously protruding out of the pipe 9 to cut further so as to damage peripheral facilities outside the pipe 9, thereby securing the safety in work.

In addition, the fixing disk 3 is designed to have a plurality of annual grooves 33 matching with various pipes 9 of different bore sizes for covering on and fix the various pipes 9 of different thickness and bore sizes in location when cutting.

Moreover, the locating seat 4 can slide along the spindle 2 to adjust the cutting member 5 to any locations of the spindle 2 for precisely cutting off the various pipes 9 of different length in one-time work with smooth cutting edge without need of any trimming work, thereby greatly saving working time. Therefore, the piper cutter of the present invention is adapted to cut pipes of different thickness, bore sizes or length.

Further, the screw rod 25 of the spindle 2 is specially designed to be connected with an additional spindle to extend the length of the spindle 2 in case that the spindle 2 is not long enough for cutting a longer pipe 9 so that the screw rod 25 of the spindle 2 allows the spindle 2 to be adapted to various pipes 9 of different length.

Furthermore, the bearing 32 of the fixing disk 3 can be a kind of sideway-moving bearing, such as an automatic center-adjusting bearing or a cylindrical roller bearing whose axis can be moved sideways, by which the bearing 32 of the fixing disk 3 is disposed at the upper portion of the spindle 2 to help the lower portion of the spindle 2 moved at a proper angle for cutting, thereby providing the pipe cutter of the present invention to be time-saving, labor-saving, easy to work and utility in industry.

While the preferred embodiment of the invention has been described above, it will be recognized and understood that various modifications may be made therein and the appended claims are intended to cover all such modifications that may fall within the spirit and scope of the invention.

What is claimed is:

1. A pipe cutter comprising:
a spindle having a fixed head disposed a top thereof, a locating rod disposed under said fixed head, a stop flange disposed under said locating rod, and a scale indicated on a body thereon;
a fixing disk fitly covered on said locating rod of said spindle and having an engagement groove disposed therein, a bearing securely mounted in said engagement groove, and a plurality of annual grooves disposed therein, said engagement groove provided with a through hole disposed therein;
a locating seat fitly covered on said body of said spindle and having a channel formed in a center thereof, a stop flange disposed at an upper portion thereof, and a stem disposed at a lower portion thereof, said stop flange having a notch formed thereon in communication with said channel and a tenon protruded at a lower portion thereof, said stem having a plurality of set members for firmly fixing said locating seat on said spindle;
a cutting member fitly covered on said locating seat and having a through hole formed in a center thereof, said through hole having a mortise formed at one side thereof;
a stop member fitly covered on said locating seat and positioned below said cutting member and having a bearing mounted thereon and a through hole formed in a center thereof;
two securing members respectively disposed on said locating rod of said spindle and said locating seat, one of said two securing members capable of securing said fixing disk on said spindle in location, and the other one of said two securing members capable of securing said cutting member and said stop member on said locating seat in location; and,
whereby said locating seat can slide along said spindle to move said cutting member to a location at a level of a required length of a pipe body to be cut so that after a socket head of a power drive unit is locked on said fixed head of said spindle, said power drive unit can be actuated to rotate said spindle with a lower portion of said spindle moved sideways to make said cutting member follow the rotation of said spindle to cut said pipe body accordingly.

2. The pipe cutter as claimed in claim 1, wherein said spindle has a screw rod disposed at a lower portion thereof for being connected with an additional spindle in case that the length of said spindle is insufficient.

3. The pipe cutter as claimed in claim 1, wherein said cutting member has an external diameter a little smaller than an internal diameter of said pipe body to be cut, and said stop member has a radius a little smaller than that of said cutting member with a radial differential between said stop member and said cutting member just to be the thickness of said pipe body.
